(19) United States
(12) Patent Application Publication
(10) Pub. No.: US 2010/0005601 A1
(43) Pub. Date: Jan. 14, 2010

(54) Reflective ink, dye or paint

(76) Inventor: Barbara C. Kantor, Boulder, CO (US)

Correspondence Address: RUTH EURE, 4795 EDISON AVENUE, BOULDER, CO, 80301, US

(21) Appl. No.: 12/460,088

(22) Filed: Jul. 14, 2009

Related U.S. Application Data
(60) Provisional application No. 61/134,813, filed on Jul. 14, 2008.

(51) Int. Cl. C09D 11/00; C09B 67/00

(52) U.S. Cl. 8/636; 106/31.14; 106/287.23; 106/286.4

(57) ABSTRACT

An ink, dye or paint containing inclusions which reflect incident light in a low ambient light environment, such as at night is provided and is transparent or invisible during the day or in high light environments. The ink, dye or paint provided comprises a fluid component which is invisible or transparent when dry and at least one inclusion that reflects visible light when incident light strikes the surface of the ink, dye or paint in low ambient light conditions, such as at night

### CLAIM OF PRIORITY

This application claims priority from U.S. Provisional Application Ser. No. 61/134,813, filed Jul. 14, 2008, of common title and inventorship herewith.

### FIELD OF THE INVENTION

This invention relates to the field of reflective coverings in the form of liquid ink, dye or paint.

### BACKGROUND OF THE INVENTION

The literature puts forth a variety of teachings directed to reflective coatings. These include, for example:

U.S. Pat. No. 4,004,930 to Tung which is directed to a Fluid Composition for Forming Retroreflective Structures. The fluid contained in this reference utilizes retroreflective platelet particles comprising flat segments of reteroreflective material.

U.S. Pat. No. 4,312,676 to Hogseth and Johnson is directed to a Retro-reflective Liquid Coating Composition which is designed to form mound-shaped retroreflective marks for rapidly actuating photoscanner sensing devices.

U.S. Pat. No. 5,059,245 to Phillips and Mayer is directed to Ink incorporating optically variable thin film flakes which incorporates optically variable thin film flakes of a multilayer thin film interference structure. This technology is also found in U.S. Pat. No. 5,279,657 of common inventorship therewith.

None of these references put forth the technology of the instant invention.

### SUMMARY OF THE INVENTION

It is an object of the present invention to provide an ink, dye or paint which has a transparent drying fluid component in combination with inclusions of any geometric configuration which will reflect light in the visible portion of the electromagnetic spectrum.

The transparent fluid component can be any transparent medium such as acrylic based inks, dyes or paints, enamel based inks, dyes or paints and gel based inks dyes or paints, for example.

The inclusions can be comprised of any transparent material such as glass, plastic or acrylic, or other polymer, for example, and can be any geometric configuration, such as beads, spheroid, ellipsoid, prisms, polyhedra, for example, irregularly shaped or regularly shaped, so that incident light impinging the surface of the inclusion will be reflected.

It is a further object of the present invention to provide an ink, dye or paint which is invisible or transparent by day, and reflects incident light in a low ambient light environment, such as at night and is transparent or invisible during the day or in high light environments.

It is a further object of the present invention to provide an ink, dye or paint which is transparent or invisible in an illuminated area, and which reflects incident light in a low ambient light environment, such as at night.

### DETAILED DESCRIPTION OF THE INVENTION

As used herein the term, “ink” refers to any fluid medium which is at least partially absorbed into the surface of the substrate onto which it is applied.

As used herein, the term, “paint” refers to any fluid medium which adheres to the surface of the substrate onto which it is applied.

As used herein, the term “dye” refers to a fluid into which the substrate is immersed or soaked.

As used herein, “substrate” is any material, textile, fabric, hard surface such as metal, plastic, wood, paper or glass, for example, which is useful for receiving the ink, dye or paint of the present invention.

As used herein, the visible light refers to light having a wavelength of about 400 nanometers to about 700 nanometers.

The reflective ink or paint of the present invention can be applied to a surface in any of a variety of ways as is known in the art. Application methods include spraying, painting, pouring, or silk-screening, for example. If it is silk-screened, care should be used to ensure that the holes in the mesh of the screen are adequate to allow passage of the inclusions to pass therethrough. Other methods of application should also take into consideration the size of the inclusions, so as to prevent clogging of nozzles if applicable.

The size of the inclusions can be of any size suitable to reflect visible light. Typically, the size of the inclusions may be from about 1 micron to about 0.1 millimeter in any diameter.

The amount of reflectivity is proportional to the amount of inclusions in the ink, dye or paint. A person of ordinary skill in the art will be able to determine the appropriate amount of inclusions for a specific volume of ink, dye or paint.

The ink, dye or paint of the present invention is useful for apparel and accessories for humans and animals.

The transparent fluid component can be any transparent medium such as acrylic based inks or paints, enamel based inks or paints and gel based inks or paints, for example, including plastisol, heat cured media, and solvent-based media.

The ink or paint of the present invention can also be applied to a transfer sheet for later application to a substrate.

It should be noted that the present invention provides an ink, dye or paint comprising reflective technology. Reflective technology, as used herein, refers to an ink, dye or paint containing inclusions which reflect incident light in a low ambient light environment, such as at night.

In contrast, “glow in the dark” technology refers to material which is exposed to a light source, absorbs light from the light source and at a later time emits light until the absorbed light is dissipated. The present invention does NOT utilize glow in the dark technology.

The ink or paint of the present invention can be applied to any suitable surface which can receive the reflective ink, dye or paint of the present invention. This includes, but is not limited to, textiles, plastics, metals, wood, for example. Applications include safety vests, and other safety clothing, any clothing, any outer wear, gloves, hats, boots, bicycles, toys, automobiles, equipment including tractors, other farm equipment, excavating or construction equipment, loaders, backhoes, steamrollers, other road-building equipment, any equipment used near streets and roads, buildings, fence posts, gates, storage containers, water troughs, sheds, barns, for example. Additional examples of surfaces useful for use with the ink, dye or paint of the present invention include: signage, patio furniture, any outdoor application such as fence posts, gates, walls or any other surface wherein illumination thereupon will provide reflection and afford increased visibility of the surface in a low ambient light environment, such as at night.

The ink, dye or paint of the present invention is useful for apparel and accessories for humans and animals.

When applied to textiles or other clothing, the ink, dye or paint of the present invention is washable. One example of many possible examples of use of the ink, dye or paint of the present invention could be a child's garment having a picture of a dinosaur painted thereon. The image of the dinosaur is applied thereto using conventional ink, dye or paint. The image of the skeleton is applied over the image of the dinosaur using the ink, dye or paint of the present invention. The result is that the image of the dinosaur is visible during the day and the image of the skeleton is visible at night, or in low ambient light when incident light strikes the image of the skeleton and the image of the skeleton is reflected.

Although this invention has been described with respect to specific embodiments, it is not intended to be limited thereto and various modifications which will become apparent to the person of ordinary skill in the art are intended to fall within the spirit and scope of the invention as described herein taken in conjunction with the appended claims.

1. A reflective ink, dye or paint comprising a fluid component which is invisible or transparent when dry and at least one inclusion that reflects visible light when incident light strikes the surface of the ink, dye or paint in low ambient light conditions, such as at night.

2. The ink, dye or paint of claim 1 comprising a transparent drying fluid component and at least one inclusion wherein the inclusion is capable of reflecting light in the visible portion of the electromagnetic spectrum.

3. The ink, dye or paint of claim 2 wherein the transparent drying fluid component is selected from the group consisting of: any transparent medium such as acrylic based inks, dyes or paints, enamel based inks, dyes or paints and gel based inks dyes or paints.

4. The ink, dye or paint of claim 2 wherein the inclusion comprises any transparent material such as glass, plastic or acrylic, or other polymer.

5. The ink, dye or paint of claim 2 wherein the inclusion comprises a geometric configuration, such as beads, spheroid, ellipsoid, prisms, polyhedra, irregularly shaped or regularly shaped, so that incident light impinging the surface of the inclusion will be reflected.

6. The ink, dye or paint of claim 1 wherein the ink, dye or paint is transparent by day, and reflective at night.

7. The ink, dye or paint of claim 1 wherein the ink, dye or paint is transparent, or invisible in an illuminated area, and is reflects incident light in a low ambient light environment.

8. The ink, dye or paint of claim 3, wherein the ink, dye or paint is suitable for use on durable goods such as bicycles.

9. The ink, dye or paint according to claim 4, wherein the inclusion comprises glass.

10. The ink, dye or paint according to claim 4, wherein the inclusion comprises plastic.

11. The ink dye or paint according to claim 3 wherein the fluid component is acrylic based ink, dye or paint.

12. The ink, dye or paint of claim 5 wherein the inclusion is spheroid.

13. The ink, dye or paint of claim 5 wherein the inclusion is ellipsoid.

14. The ink, dye or paint of claim 1 useful for apparel and accessories for humans and animals.

15. The ink, dye or paint, according to claim 1, wherein the size of the inclusion ranges from about 1 micron to about 0.1 millimeter in any diameter.
